(19) United States
(12) Patent Application Publication
(10) Pub. No.: US 2008/0225927 A1
(43) Pub. Date: Sep. 18, 2008

(54) Transmission method

(75) Inventors: Noriaki Miyazaki, Fujimino-shi (JP); Toshinori Suzuki, Fujimino-shi (JP); Fumio Watanabe, Tokyo (JP)

Correspondence Address: MORGAN LEWIS & BOCKIUS LLP, 1111 PENNSYLVANIA AVENUE NW, WASHINGTON, DC, 20004, US

(73) Assignee: KDDI Corporation, Tokyo (JP)

(21) Appl. No.: 12/148,084

(22) Filed: Apr. 15, 2008

(30) Foreign Application Priority Data
Oct. 28, 2005 (JP) 2005-314152

(51) Int. Cl. H04B 1/707; H04L 27/10

(52) U.S. Cl. 375/141; 375/223; 375/E01.002

(57) ABSTRACT

In a transmission method of the present invention, when transmitting an information bit from a transmitter to a receiver, an encoder of the transmitter firstly inputs and encodes the information bit, and a modulator then modulates the encoded information bit to create a modulation symbol. A spreader spreads the obtained modulation symbol using a rotation orthogonal code having a rotation angle that is appropriate to a combination of the modulation method and the coding rate, and transmits it to a transmission path. The receiver performs a reverse operation of the transmitter, and decodes the information bit. In QPSK modulation where the coding rate of an error-correction code is ½, when a rotation angle that obtains a same signal point as OFDM is 0°, spreading is performed using a rotation orthogonal code having a rotation angle of between 17° and 45°, or between −17° and −45°, thereby reducing bit error and enabling highly-reliable communication to be achieved.

### TECHNICAL FIELD

The present invention relates to a transmission method using rotation orthogonal coding.

Priority is claimed on Japanese Patent Application No. 2005-314152, filed Oct. 28, 2005, the content of which is incorporated herein by reference.

### BACKGROUND ART

In new-generation mobile communication systems, multi-carrier transmission schemes are being regarded as effective, instead of single carrier transmission schemes. Representative examples of multicarrier transmission schemes are Orthogonal Frequency Division Multiplex (OFDM) schemes and Multi-Carrier Code Division Multiple Access (MC-CDMA) schemes.

In MC-CDMA, a modulation symbol is spread over a plurality of subcarriers and transmitted in multiplex, thereby obtaining frequency diversity and mitigating inter-cell interference. A rotation orthogonal code obtains hybrid characteristics of OFDM and MC-CDMA using a Walsh code, and is proposed as a spread code for MC-CDMA (e.g. see Non-Patent Document 1, below). At a spread rate of 2, if an n-th modulation symbol is Mᵢ(n), n-th data subcarrier Dᵢ(n) spread by the rotation orthogonal code is expressed with equation (1).

$$\{ \begin{matrix}{D}_{t} ( n ) = \sqrt{2} \{ {M}_{t} ( n ) cos {θ}_{1} + {M}_{t} ( n + 1 ) sin {θ}_{1} \} \\ {D}_{t} ( n + 1 ) = \sqrt{2} \{ - {M}_{t} ( n ) sin {θ}_{1} + {M}_{t} ( n + 1 ) cos {θ}_{1} \}\end{matrix} \qquad ( 1 )$$

If a rotation orthogonal code with a spread rate of 2 is expressed as a matrix of equation (2), equation (1) can be rewritten as equation (3), and a rotation orthogonal code with a spread rate of more than two is obtained from equation (4).

$$\begin{matrix}{C}_{2} = \sqrt{2} [ \begin{matrix}cos {θ}_{1} & sin {θ}_{1} \\ - sin {θ}_{1} & cos {θ}_{1}\end{matrix} ] & ( 2 ) \\ [ \begin{matrix}{D}_{t} ( n ) \\ {D}_{t} ( n + 1 )\end{matrix} ] = {C}_{2} [ \begin{matrix}{M}_{t} ( n ) \\ {M}_{t} ( n + 1 )\end{matrix} ] & ( 3 ) \\ {C}_{{2}^{N}} = {( \sqrt{2} )}^{N} [ \begin{matrix}{C}_{{2}^{N - 1}} cos {θ}_{N} & {C}_{{2}^{N - 1}} sin {θ}_{N} \\ - {C}_{{2}^{N - 1}} sin {θ}_{N} & {C}_{{2}^{N - 1}} cos {θ}_{N}\end{matrix} ] & ( 4 )\end{matrix}$$

FIG. 9 is a diagram of transmission signal points when a quadrature phase shift keying (QPSK) modulation symbol is spread using a rotation orthogonal code with a spread rate of 2. The signal points in FIG. 9 are obtained by converting post-spread transmission signal points to symbols for maximum likelihood estimation (see Non-Patent Document 1, below).

As shown in FIG. 9, when θ₁=0, OFDM modulation symbols are obtained, and when θ₁=π4, MC-CDMA modulation symbols spread using a Walsh code are obtained. Therefore, by applying values from 0 to π/4 as the rotation angle of a rotation orthogonal code, frequency diversity can be controlled, and intermediary characteristics of MC-CDMA using OFDM and Walsh coding can be obtained.

(Non-Patent Document 1) 3GPP TSG RAN WG1#42 bis, R1-051261, “Enhancement of Distributed Mode for Maximizing Frequency Diversity,” Oct. 2005.

(Non-Patent Document 2) D. Garg and F. Adachi, “Diversity-Coding-Orthogonality Trade-off for Coded MC-CDMA with High Level Modulation,” IEICE Trans.

Commun., Vol. E88-B, No. 1, pp. 76-83, Jan. 2005.

Non-Patent Document 2 reports that signal-to-noise power ratio for obtaining a required packet error rate differs according to the modulation scheme, the coding rate of the error-correction code, and the transmission scheme. That is, an optimum transmission scheme differs according to the channel format such as the modulation scheme and the coding rate of the error-correction code, there being cases where the required OFDM signal-to-noise power ratio is lower than that of MC-CDMA, and cases where it is higher.

### DISCLOSURE OF THE INVENTION

Thus, while the rotation angle of the rotation orthogonal code that obtains the minimum required signal-to-noise power ratio also differs according to the channel format, this has not yet been reported. If, in a transmission scheme using a rotation orthogonal code, it were possible to spread using a rotation orthogonal code having a rotation angle appropriate to the transmission channel format, bit errors could be reduced, and highly reliable communication would be possible.

The present invention has been realized in view of these circumstances, and aims to provide a rotation orthogonal code having a rotation angle that is appropriate for a combination of the modulation scheme and the coding rate of the error-correction code.

The present invention has been realized in order to solve these problems. A transmission method according to the invention spreads a signal using a rotation orthogonal code, and uses a rotation orthogonal code having a rotation angle that differs according to a combination of a modulation scheme and the coding rate of an error-correction code.

Further, a transmission method that spreads a signal using a rotation orthogonal code according to the invention uses a rotation orthogonal code having a rotation angle of between 7° and 45°, or between −7° and −45° where a rotation angle that obtains a same signal point as OFDM is 0°.

Also, a transmission method that spreads a signal using a rotation orthogonal code according to the invention uses a rotation orthogonal code having a rotation angle of between 17° and 45°, or between −17° and −45° in QPSK modulation where a rotation angle that obtains a same signal point as OFDM is 0°.

Furthermore, a transmission method that spreads a signal using a rotation orthogonal code according to the invention uses a rotation orthogonal code having a rotation angle of between 18° and 45°, or between −18° and −45° in QPSK modulation where the coding rate of an error-correction code is ⅘, and where a rotation angle that obtains a same signal point as OFDM is 0°.

Furthermore, a transmission method that spreads a signal using a rotation orthogonal code according to the invention uses a rotation orthogonal code having a rotation angle of between 12° and 42°, or between −12° and 42° in 16 QAM modulation where the coding rate of an error-correction code is ¾, and where a rotation angle that obtains a same signal point as OFDM is 0°.

According to the present invention, in a transmission method of spreading a signal using a rotation orthogonal code, the signal can be spread with a rotation orthogonal code having a rotation angle that is appropriate for a combination of the modulation scheme and the coding rate of the error-correction code.

### BRIEF DESCRIPTION OF THE DRAWINGS

FIG. 1 is a block diagram showing an example of a transceiver carrying out a transmission method of spreading a signal using a rotation orthogonal code according to the invention.

FIG. 2 is a table showing simulation parameters.

FIG. 3 is a diagram showing results obtained by simulation of normalized packet error rate when the rotation angle of the rotation orthogonal code is changed, under conditions of modulation scheme: QPSK, coding rate: ½, number of information bits: 1024.

FIG. 4 is a diagram showing results obtained by simulation of normalized packet error rate when the rotation angle of the rotation orthogonal code is changed, under conditions of modulation scheme: QPSK, coding rate: ⅔, number of information bits: 2048.

FIG. 5 is a diagram showing results obtained by simulation of normalized packet error rate when the rotation angle of the rotation orthogonal code is changed, under conditions of modulation scheme: QPSK, coding rate: ¾, number of information bits: 3072.

FIG. 6 is a diagram showing results obtained by simulation of normalized packet error rate when the rotation angle of the rotation orthogonal code is changed, under conditions of modulation scheme: QPSK, coding rate: ⅘, number of information bits: 4096.

FIG. 7 is a diagram showing results obtained by simulation of normalized packet error rate when the rotation angle of the rotation orthogonal code is changed, under conditions of modulation scheme: 16 QAM, coding rate: ⅔, number of information bits: 4096.

FIG. 8 is a diagram showing results obtained by simulation of normalized packet error rate when the rotation angle of the rotation orthogonal code is changed, under conditions of modulation scheme: 16 QAM, coding rate: ¾, number of information bits: 3072.

FIG. 9 is a diagram showing transmission signal points when a QPSK modulation symbol is spread using a rotation orthogonal code with a spread rate of 2.

### BEST MODE FOR CARRYING OUT THE INVENTION

An embodiment of the invention will be explained with reference to the drawings.

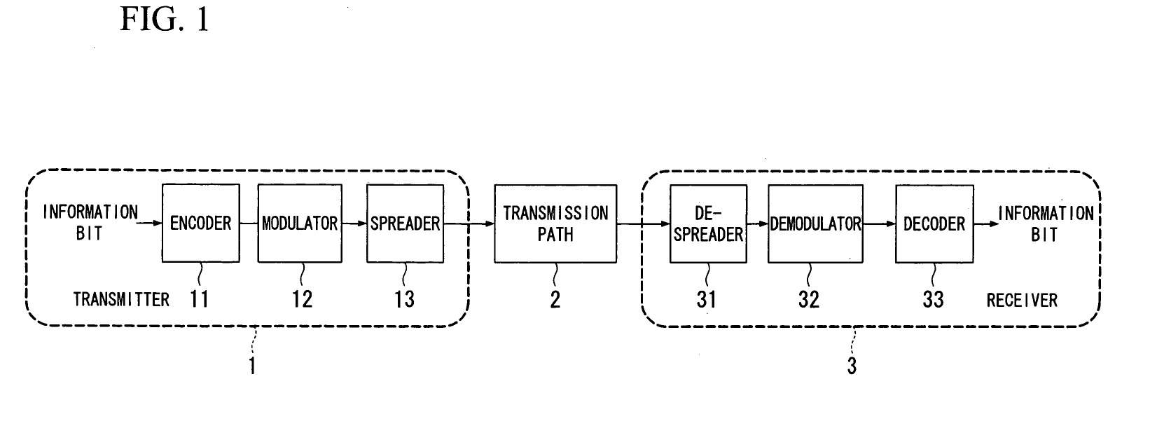

FIG. 1 shows an example of a transceiver block diagram of a transmission method of spreading a signal using a rotation orthogonal code. In FIG. 1, when transmitting an information bit from a transmitter 1 to a receiver 3, an encoder 11 of the transmitter 1 firstly inputs and encodes the information bit, and a modulator 12 then modulates the encoded information bit to create a modulation symbol.

A spreader 13 spreads the obtained modulation symbol using a rotation orthogonal code having a rotation angle appropriate to a combination of the modulation method and the coding rate, and transmits it to a transmission path 2. In the receiver 3, a de-spreader 31 de-spreads the signal received from the transmission path 2, a demodulator 32 demodulates the de-spread signal, and a decoder 33 decodes the information bit.

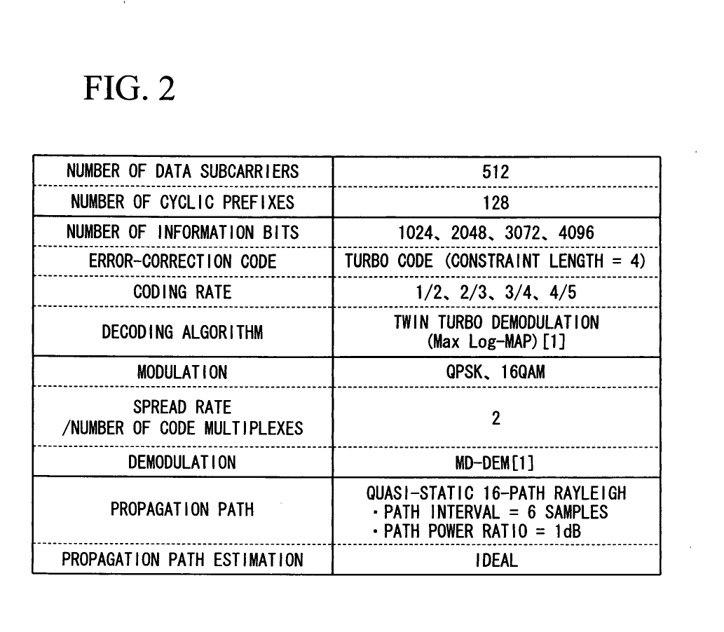

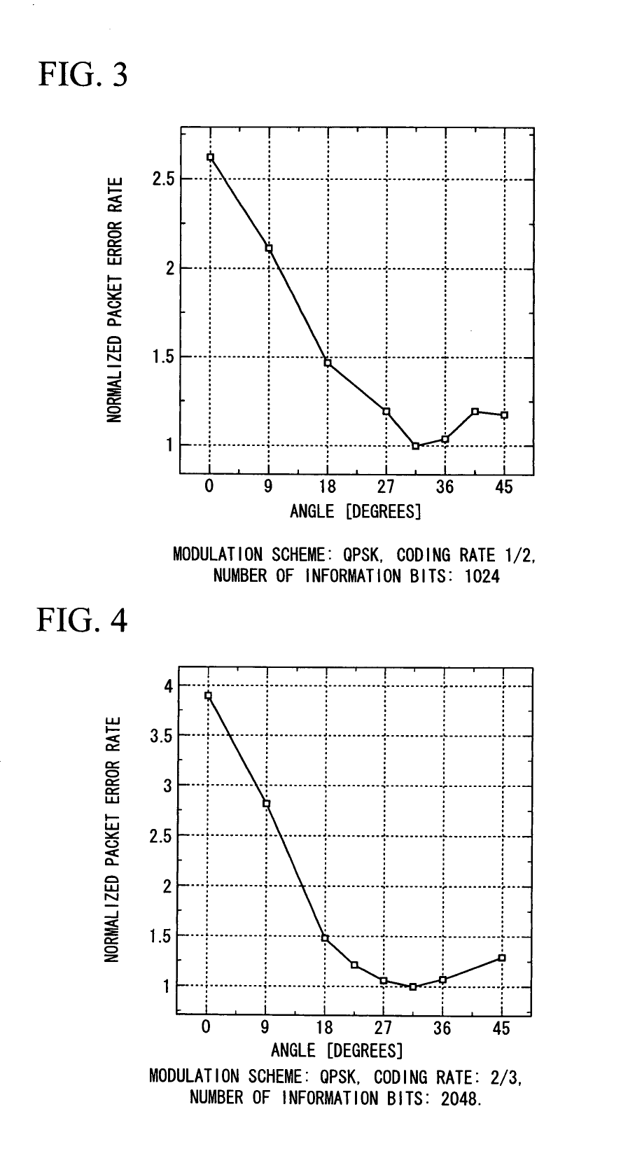

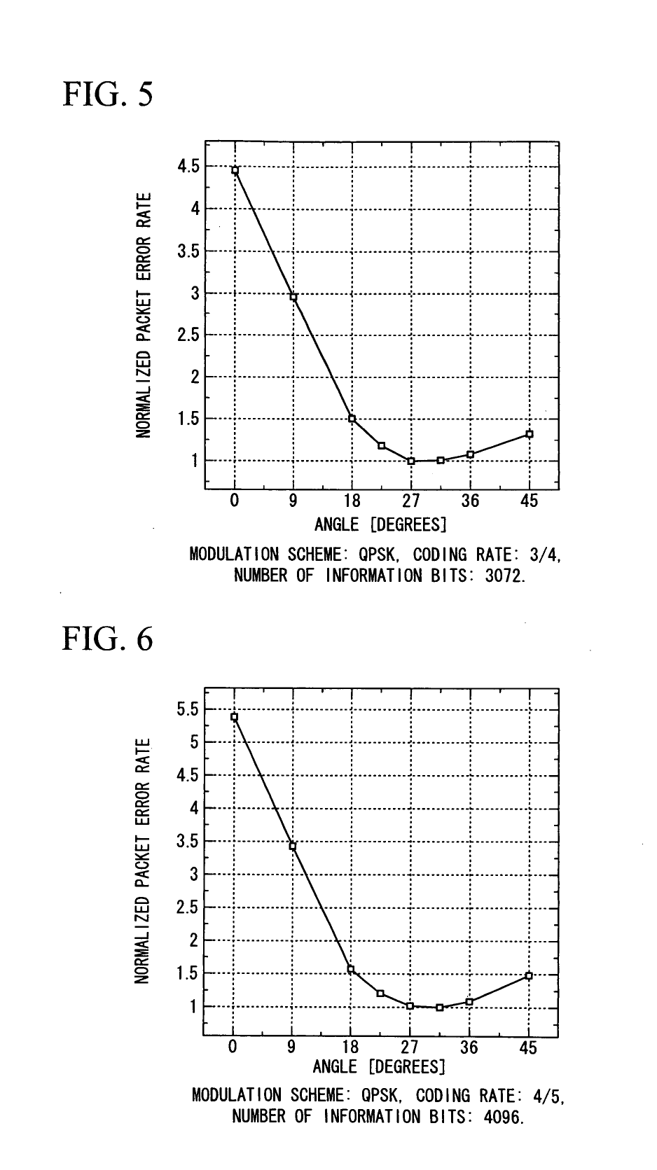

Subsequently, the rotation angle appropriate to a combination of a modulation method and a coding rate that is used in the spreading performed by the spreader 13 will be explained with reference to FIGS. 2 to 8. FIGS. 3 to 8 are diagrams of results obtained by calculator simulations in evaluations of a packet error rate for each combination of a modulation method and a coding rate, when the rotation angle is changed, and FIG. 2 is a graph of simulation parameters in the simulations.

In FIG. 2, the number of data subcarriers, which is the number of subcarriers that modulate the data, is 512 in this embodiment. To suppress multi-path interference, the number of cyclic prefixes, which is a copy of the MC-CDMA symbol tail inserted before the MC-CDMA modulation symbol, is 128 in this embodiment.

The number of information bits, which is the number of information bits transmitted form the transmitter 1 of FIG. 1, is one of 1024, 2048, 3072, and 4096 in this embodiment. A turbo code having a constraint length of 4 is used as an error-detection code. The coding rate, is the ratio of information bits contained to the coded bits, is one of ½, ⅔, ¾, and ⅘.

A decoding algorithm, which is an algorithm used in decoding performed by the decoder 33 of FIG. 1, uses twin turbo demodulation (Max Log-MPA algorithm, see Non-Patent Document 1). One of QPSK and 16 QAM (Quadrature Amplitude Modulation) is used as the modulation scheme.

The spread rate/number of code multiplexes, which are the spread rate and number of code multiplexes in a code spread process implemented by the decoder 33 of FIG. 1, are both 2 in this embodiment. MD-DEM (see Non-Patent Document 1) is used as the demodulation method. The propagation path is an independent quasi-static 16-path Rayleigh model that is constant within one frame, and exponentially decays with a delay time difference of six samples between paths. It is assumed that propagation path estimation is ideal.

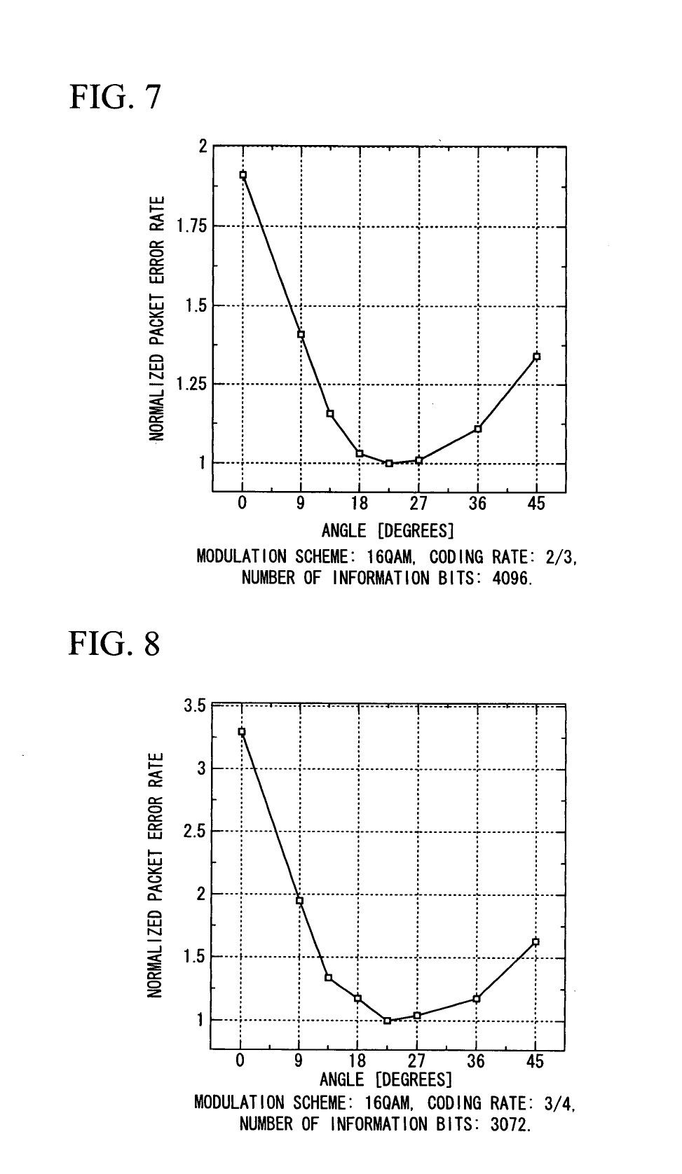

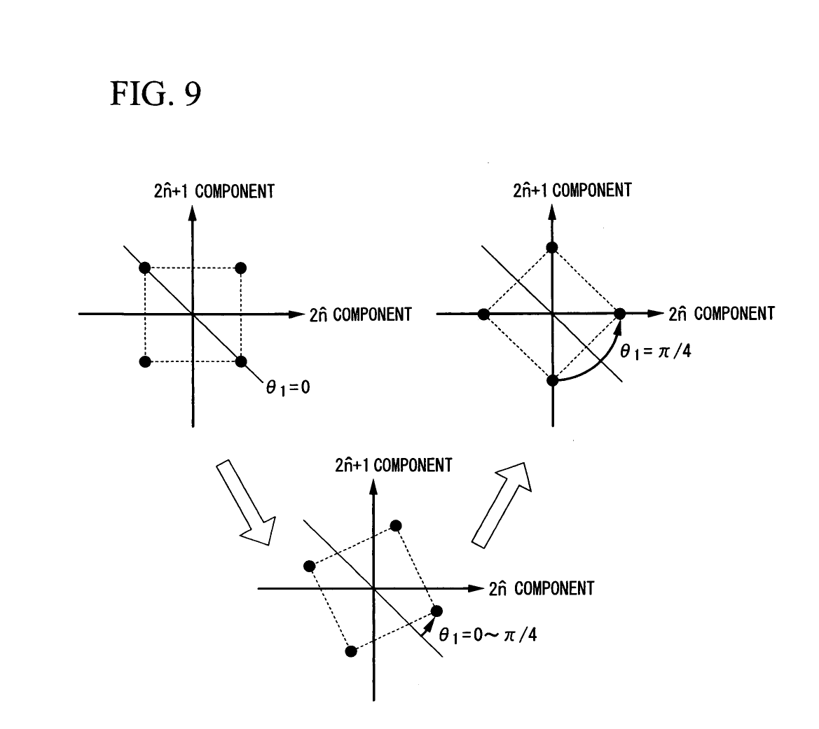

FIGS. 3 to 6 are graphs of normalized packet error rates for QPSK modulation using error-correction coding rates of ½, ⅔, ¾, and ⅘. Here, the normalized packet error rate is obtained by normalizing the packet error rates at each rotation angle using the minimum packet error rate obtained by changing the rotation angle by 4.5° each time from 0°. A rotation angle of 0° is one that obtains the same signal as OFDM (the same applies in FIGS. 7 and 8).

As shown in FIGS. 3 to 6, the rotation angle has an optimum value that minimizes the packet error rate. Also, even if a packet error rate of 1.5 times the minimum packet error rate is permitted, the rotation angle must be controlled such that it is between 17° and 45° in QPSK modulation at coding rates of ½, ⅔, and ¾, and between 18° and 45° in QPSK modulation at a coding rate of ⅘.

An increase in the packet error rate can lead to a deterioration in the communication quality, and make it difficult to provide subscribers with adequate services. In particular, in a user datagram protocol (UDP) application that does not retransmit information even if a packet error occurs, when the packet error rate is greater than 1.5 times, it becomes difficult to continue communication even if using a transmission scheme where appropriate modulation is performed in accordance with propagation path fluctuations. Furthermore, it can be confirmed that the increase in the normalized packet error rate with respect to changes in the rotation angle is larger in regions where the normalized packet error rate is greater than 1.5 than in regions where it is less than 1.5.

FIGS. 7 and 8 are graphs of normalized packet error rates for 16 QAM modulation using error-correction coding rates of ⅔ and ¾. As in the QPSK modulation, the rotation angle has an optimum value that minimizes the packet error rate; for example, even if a packet error rate of 1.5 times the minimum packet error rate is permitted, the rotation angle must be controlled such that it is between 7° and 45° in 16 QAM modulation at a coding rate of ⅔, and between 12° and 42° in 16 QAM modulation at a coding rate of ¾. Incidentally, since the change in the normalized packet error rate when the rotation angle is changed is a 0° target in FIGS. 3 to 8, the same normalized packet error rate is obtained at x° and −x°.

As described in detail above, according to the invention, in a transmission method of spreading a signal using a rotation orthogonal code, it is possible to spread a signal with a rotation orthogonal code having a rotation angle that is appropriate for a combination of the modulation scheme and the coding rate of the error-correction code. While the simulation results shown in FIGS. 3 to 8 were obtained using a turbo code as the error-correction code, the range of the rotation angle that is appropriate for a combination of the modulation scheme and the coding rate does not change even if another code, such as a low-density parity-check code, is used instead.

Furthermore, while a Max Log-MAP algorithm was used as the decoding method, the range of the rotation angle that is appropriate for a combination of the modulation scheme and the coding rate does not change even if another code, such as a Log-MAP algorithm is used instead. Moreover, while a 16-path Rayleigh model that exponentially decays at intervals of six samples was used as the multi-path model, the range of the rotation angle that is appropriate for a combination of the modulation scheme and the coding rate does not change even if another multi-path model is used instead.

### INDUSTRIAL APPLICABILITY

The present invention is suitable for use in a transmission method using rotation orthogonal code.

1. A transmission method that spreads a signal using a rotation orthogonal code, comprising using a rotation orthogonal code having a rotation angle that differs according to a combination of a modulation scheme and the coding rate of an error-correction code.

2. A transmission method that spreads a signal using a rotation orthogonal code, comprising using a rotation orthogonal code having a rotation angle of between 7° and 45° , or between −7° and −45° where a rotation angle that obtains a same signal point as OFDM is 0°.

3. A transmission method that spreads a signal using a rotation orthogonal code in QPSK modulation, comprising using a rotation orthogonal code having a rotation angle of between 17° and 45°, or between −17° and −45° where a rotation angle that obtains a same signal point as OFDM is 0°.

4. A transmission method that spreads a signal using a rotation orthogonal code in QPSK modulation where the coding rate of an error-correction code is ⅘, using a rotation orthogonal code having a rotation angle of between 18° and 45°, or between −18° and −45° where a rotation angle that obtains a same signal point as OFDM is 0°.

5. A transmission method that spreads a signal using a rotation orthogonal code in 16 QAM modulation where the coding rate of an error-correction code is ¾, using a rotation orthogonal code having a rotation angle of between 12° and 42°, or between −12° and −42 where a rotation angle that obtains a same signal point as OFDM is 0°.
